(19) United States
(12) Patent Application Publication
(10) Pub. No.: US 2005/0200604 A1
(43) Pub. Date: Sep. 15, 2005

(54) Mouse Cover

(76) Inventor: Leonard P. Norman, Hillsboro, OR (US)

Correspondence Address: GREENBERG & LIEBERMAN, 314 PHILADELPHIA AVE., TAKOMA PARK, MD, 20912, US

(21) Appl. No.: 10/708,574

(22) Filed: Mar. 11, 2004

(51) Int. Cl. G09G 5/08

(52) U.S. Cl. 345/163

(57) ABSTRACT

A mouse cover that fits and tightly clasps onto the conventional mouse because of the concave slanted sides and elastic form fitted material it is made of. Because of the form fitted contour, the mouse cover remains securely engaged on the conventional mouse while the mouse is in use. The present invention provides the user complete access to the function member keys located on the top surface of the conventional mouse. The present invention adds the personal touch to the office environment. People delight in adding function with flair, design, fashionable additions and vibrant colors to their office environments. The present invention improves the functionality of the conventional mouse, as well as improving the aesthetic view of the office and home office.

### BACKGROUND OF INVENTION

The present invention relates to a computer mouse cover, more particularly a flexible form fitting computer mouse cover.

The use of computers is very prevalent in our daily lives. Computers can be found in offices, homes, hospitals, schools and practically any other work, business, entertainment or dwelling environment. Using a computer is key for communication, accessing the Internet, conducting business, shopping, creating documents, teaching, learning and many other functions of everyday life.

A computer mouse is one of the devices used in conjunction with using a computer. A typical computer mouse is a hand-operated device that sends control signals to a computer through a cable. The signals sent control and command the functioning of the computer. Many computer functions and operations require using the mouse to point to various items on the computer monitor screen. The user generates control signals by manipulating the mouse. The control signals are generated by translating the mouse across a surface, usually a foam pad, and by manipulating actuation member buttons on top of the mouse. These translations cause either the movement of a rolling member that protrudes from the bottom of the mouse, or actuation of a laser driven position registering device. The translation of the mouse controls the position of the cursor on a computer display screen. The user may depress one or more actuation members that are part of the mouse. The actuation members are generally located on a region of the mouse accessible to the user's fingers. Typically, there are no actuation members on a broad region of the housing that fits beneath the user's palm. The computer mouse is essential to the use of computers. In recent years, the mouse has evolved into various shapes with various features, making it more compact and easier to hold. While the shape has changed, the functionality has remained the same.

While the purpose of the mouse is rather banal, the mouse serves as a perfect platform from which to present messages, advertising, or simply show allegiance to a sports team. However, covering mice seems all but impossible because they are not only formed in odd shapes, and need to be able to glide across a flat surface, but also they demand that the user have access to buttons and oftentimes a flywheel. Thus, if a mouse cover were to be practical, it would need to avoid interference with the functionality of the mouse.

There is a need for a mouse cover, whether for comfort, novelty, or ergonomics, that fits securely and easily on a mouse without interfering with the mouse's functions and obscuring buttons and movement. Several previous devices have been the subject of patents, but they are unlike the present invention.

U.S. Pat. No. 5,245,146 issued to Linda K. Florence on Sep. 14, 1993, shows a protective cover for a computer mouse having pivotal levers with projections for engaging the pushbuttons that control the contact buttons on the mouse to signal commands to a computer. Florence's device is shaped like a car and the device covers the predominant surface of the mouse, including mouse buttons, unlike the present invention.

U.S. Pat. No. D438,865 issued to David E. Smith on Mar. 13, 2001, is a mouse cover shaped and designed like an actual mouse. Unlike the present invention, Smith's device does not follow the contour of a typical mouse, and moreover, Smith's device interferes with the normal operation of a mouse.

U.S. Patent Publication No. 20020005835 A1, published on Jan. 17, 2002, invented by Leonard Florence et al., is a mouse cover made of a metallic material, preferably silver, silver plated, metal, copper, steel or pewter which presents an inflexible, hard molded material that covers nearly the entire mouse, including actuation buttons. Unlike the present invention, Florence et al.'s device does not have a flexible surface capable of quickly securing to a mouse during use but then capable of easy removal. Moreover, unlike the present invention, Florence et al.'s device obscures the actuation buttons.

U.S. Pat. No. 6,040,539 issued to Hiegel on Mar. 21, 2000, for the protective cover for a computer mouse is made of thin, flexible, elastic material such as latex or silicone rubber and it covers the entire mouse, unlike the present invention.

Design patents U.S. Pat. No. D453,335 issued to Downs on Feb. 5, 2002, U.S. Pat. No. D438,212 issued to Whitenack on Feb. 27, 2001, and U.S. 20020190951 A1 issued to Joo on Dec. 19, 2002, do not resemble the features and functionality of the present invention.

Therefore, despite the attempts made by relevant art, there still exists a need for a mouse cover that is pliable and fits tightly around the mouse, but does not cover the entire mouse to interfere with button or wheel operation. Further, there is still a need for a mouse cover that attaches reliably to a mouse, but is capable of quickly and easily detaching should the user desire an identical mouse cover with a different look to be attached atop the mouse. None of the relevant patents, taken alone or in combination, suggests a design in like or kind to the present invention. Moreover, none of the relevant patents can preserve functionality, provide easy fitting, and remain lightweight.

### SUMMARY OF INVENTION

The present invention is a mouse cover that fits tightly onto the conventional mouse because of the concave and slanted sides and elastic form fitted material it is made of. The present invention remains on the conventional mouse while it is in use, while still providing the user complete access to the function member keys on a conventional mouse. The present invention also relates to a mouse cover by adding an element of personalization to a conventional mouse. Almost all office workers use a mouse, and a mouse cover provides an excellent way to advertise and/or display important information for user. The quick and easy attachment and detachment of the present invention to a mouse makes it ideal for simple removal and reattachment depending upon the desire of the user.

In the last fifteen to twenty years, people have been spending more time in their home offices as well as their conventional offices. People delight in adding function with flair, design, fashionable additions and vibrant colors, to their office environment. The present invention improves the functionality of the conventional mouse, as well as the aesthetic view of the home or office computer space. Having the right setting, design and color scheme all contributing to an aesthetically pleasing environment, can improve productivity in the work place.

The present invention provides a mouse cover that clasps tightly onto a conventional mouse. The cover provides a cavity defined by end and sidewalls and a top. The bottom opens into the cavity and the conventional mouse is inserted into the cavity through the bottom. The present invention tightly clasps onto the conventional mouse because of the elasticity and non-molded flexible material that the present invention is made of. The nature of elasticity and flexibility of the material used secures the present invention onto a conventional mouse. Furthermore, the slightly curved side and back planes concave towards the lower leading edge of the conventional mouse, add to the present invention's ability to clasp onto a conventional mouse. However, the lower leading edge of the present invention does not extend all the way down to the end of the conventional mouse, therefore the movement of the conventional mouse is not impaired. The present invention will not cause a dragging effect against a conventional mouse pad. The operating buttons of the conventional mouse are completely exposed when the present invention is employed onto the conventional mouse. The present invention does not impair the ordinary functioning of the conventional mouse. The top and sides exterior planes of the present invention can be molded to have any decorative insignia, color scheme, or design idea.

### BRIEF DESCRIPTION OF DRAWINGS

FIG. 1 is an environmental view of the present invention attached to a conventional mouse.

FIG. 2 is a left side view of the present invention before placing it onto a conventional mouse.

FIG. 3 is a left side view of the present invention after placing it onto a conventional mouse.

FIG. 4 is a back view of the present invention.

FIG. 5 is a right side view of the present invention.

FIG. 6 is a front view of the present invention.

FIG. 7 is a right side view of an alternative embodiment of the present invention attached to a conventional mouse.

### DETAILED DESCRIPTION

Turning to FIG. 1, the mouse cover 10 is shown attached to a conventional mouse 20. The mouse cover 10, is made of a molded, pliable, but durable material, shaped to tightly fit on a conventional mouse 20. The mouse cover 10 is engaged by placing it on top of a conventional mouse 20 and pressing downward. The mouse cover 10 has a cupped shape and is made of a plastic, pliable material so that when pressure is applied to the top region 30 of the mouse cover 10, the side planes 50 and the bottom edge 110 expand slightly and stretch outward to slide down the sides of a conventional mouse 20 and clasp tightly around the conventional mouse 20. In the same motion, the bottom edge 110 of the mouse cover 10 moves medial that is, toward the center of the mouse cover 10—to tightly fit around the conventional mouse 20. When this is done, the mouse cover 10 will fit firmly and securely around a conventional mouse 20, as shown in FIG. 1.

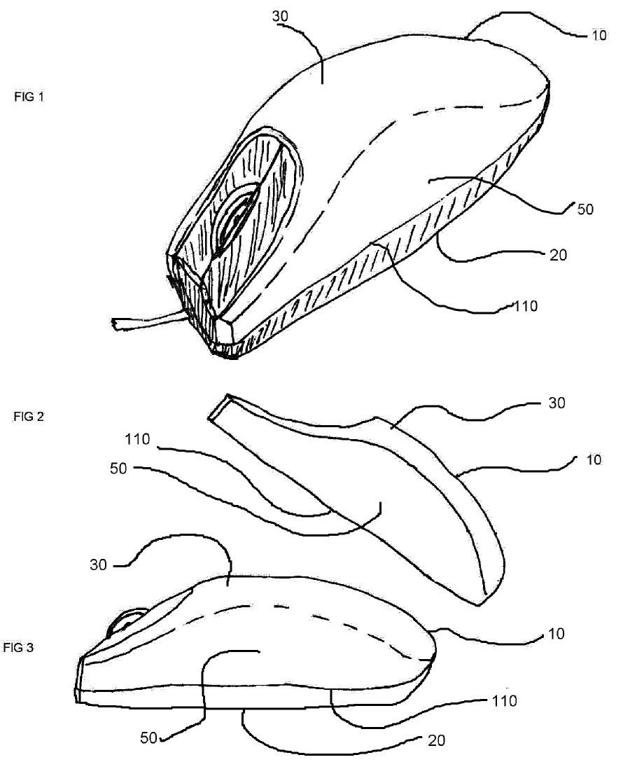

Turning to FIG. 2 and FIG. 3, the mouse cover 10 is shown before and after it is pressed down into place over a conventional mouse 20. The mouse cover 10 is placed on top of the conventional mouse 20, and slight pressure is applied to the top region 30 and the mouse cover 10 snaps into place over the conventional mouse, as shown in FIG. 3. Once in place, the mouse cover 10 fits tightly and stays in place around the conventional mouse 20. The present invention will not slip or slide off the conventional mouse 20.

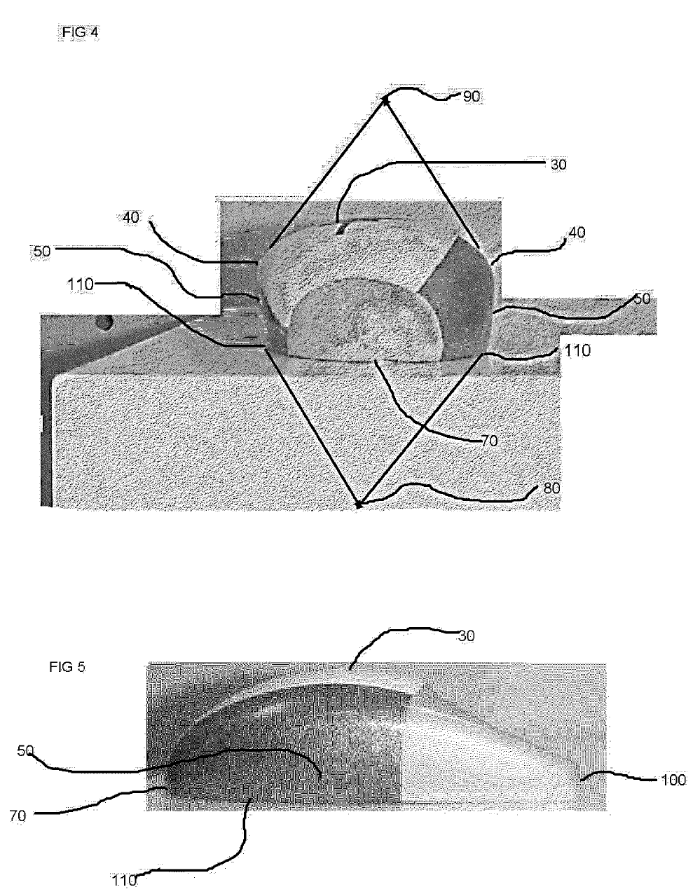

Turning to FIG. 4, the rear view of the mouse cover 10 is shown. This view shows how the unique shape of the mouse cover 10 contributes to its functionality. The unique shape is one of the characteristics that allow the mouse cover 10 to fit the conventional mouse 20 without slipping and or sliding off while being used. The top region 30 of the mouse cover 10 is shown; this is the area of the mouse cover 10 that fits into the palm area of a user's hand. The top corner edges 40 are rounded downward to create a concave effect along the side planes 50 of the mouse cover 10. The side planes 50 terminate at the bottom edge 110, and at the bottom edge 110 the mouse cover 10 fits tightly around the conventional mouse 20. The rear edge 70 of the bottom edge 110 is concave and slants to cradle the back end of the conventional mouse 20 when the mouse cover 10 is employed onto the conventional mouse 20.

Important to the functioning of the present invention is that the slanted and concave side planes 50 create a posterior smaller width 80 between the two points of the bottom edge 110, than the anterior wider width 90 between the two points of the top corner edges 40 as shown in FIG. 4. This allows the top region 30 to be wider than the smaller width 80. These features allow for the mouse cover 10 to fit tightly around a conventional mouse 20. FIG. 5 is a side view of the present invention that shows the mouse cover 10 without a conventional mouse 20 within it. It is offered to assist in understanding the shape of the present invention as aforementioned, with numbered references corresponding as aforementioned and further described.

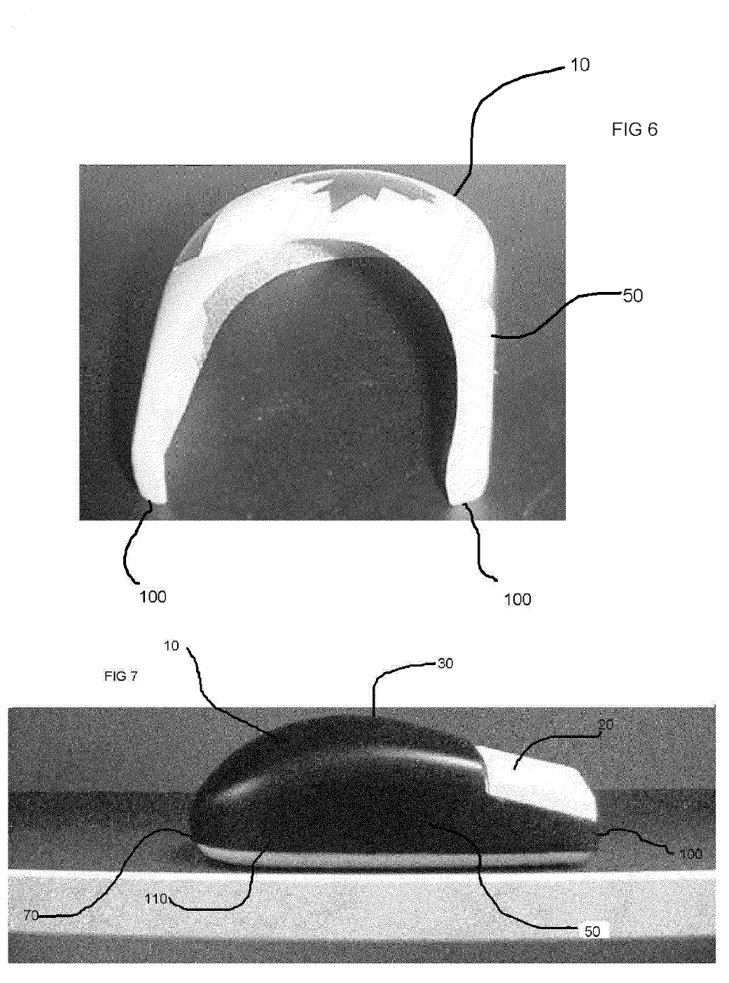

FIG. 6, as a front view of the present invention, shows the slightly curved tips 100 of the mouse cover 10. The curved tips 100 are important because they cradle the bottom front edge of the conventional mouse 20, allowing the mouse cover 10 to fit securely around the conventional mouse 20. The slightly curved tips 100 of the mouse cover 10 are extensions of the side planes 50 to “cup”the front corners of conventional mouse 20. These delineated features, in conjunction with the plastic flexible material of the mouse cover 10, allow the mouse cover 10 to easily clasp and remain secured onto a conventional mouse 20.

Turning to FIG. 7, an alternative shape of the present invention is shown, such that top region 30 of the mouse cover 10 is not quite as rounded as in the preferred embodiment of the present invention already depicted in previous figures; yet, the rest of the present invention is essentially the same as aforementioned, and is numbered appropriately. The alternative shape, and other slight variations in contour, might be necessary depending upon the general shape of the conventional mouse 20, as a conventional mouse 20 comes in a variety of shapes. As in the other embodiments of the present invention, because bottom edge 110 ends before the bottom of conventional mouse 20, there is no drag affect against a conventional mouse pad; when the user is using the conventional mouse with the present invention employed. If the bottom edge 110 continued to the bottom of the conventional mouse 20, the dragging affect could well impede the movement of the conventional mouse 20.

In FIG. 7, the present invention appears sleek and form fitting to cover the conventional mouse 20. There is no indication that the present invention is loose fitting, bulky, non-form fitting or larger that the conventional mouse 20. The present invention so closely resembles the contour of a conventional mouse 20, so that using the conventional mouse 20 with the present invention attached does not present a different feeling for the user. The characteristic comfort, ease of use, and sleekness of the present invention all still present with the present invention attached on top the conventional mouse 20 as in FIG. 7.

The present invention can have alternative embodiments so that practically any design can be displayed and molded onto the outer layer of plastic forming the surface of the present invention, and thus, into the design of the present invention. For example the present invention can have the colors of a flag, a favorite sports team or even a favorite alma mater school colors and or logo.

The present invention should not be construed as being the merely the embodiments described above, but additionally, the present invention should be construed as any and all embodiments within the scope of the following claims.

1. A computer mouse cover for a computer mouse, comprising:
an anterior width of material; and
a posterior width of material, in communication with said anterior width of material;
wherein said anterior width of material is larger than said posterior width of material.

2. The computer mouse cover of claim 1, wherein said anterior width of material is flexible.

3. The computer mouse cover of claim 1, wherein said posterior width of material is flexible.

4. The computer mouse cover of claim 1, wherein said anterior width of material is measured between anterior ends of side walls of the computer mouse.

5. The computer mouse cover of claim 1, wherein said posterior width of material is measured between posterior ends of side walls of the computer mouse.

6. The computer mouse cover of claim 4, wherein said posterior width of material is measured between posterior ends of side walls of the computer mouse.

7. The computer mouse cover of claim 1, further comprising curved tips protruding perpendicular to and in communication with said posterior width.

8. The computer mouse cover of claim 7, wherein said curved tips are formed to engage the front of the computer mouse.

9. The computer mouse cover of claim 1, wherein said anterior width of material is formed to engage the anterior ends of side walls of the computer mouse.

10. The computer mouse cover of claim 1, wherein said posterior width of material is formed to engage the posterior ends of side walls of the computer mouse.
